(19) United States
(12) Patent Application Publication
(10) Pub. No.: US 2007/0220613 A1
(43) Pub. Date: Sep. 20, 2007

(54) Digital Data Storage Apparatus, Digital Data Storage Method, Digital Data Storage Program Recording Medium, And Digital Data Processing System

(75) Inventor: Takeshi Ohtani, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/610,577

(22) Filed: Dec. 14, 2006

(30) Foreign Application Priority Data
Mar. 2, 2006 (JP) 2006-056497

(51) Int. Cl. H04L 9/32

(52) U.S. Cl. 726/27

(57) ABSTRACT

A digital data storage apparatus includes a digital data input unit that receives an upload of digital data, a digital data storage unit that stores the uploaded digital data, an authentication data generation unit that generates authentication data to associate with the stored digital data for accessing the digital data, an authentication data output unit that outputs the generated authentication data, an authentication data input unit that inputs authentication data together with identification data that identifies a download destination, an authentication unit that authenticates the input authentication data, and a digital data output unit that downloads, if authentication is successful, the digital data that has been associated to the authentication data to the download destination that is identified by the identification data.

### PRIORITY INFORMATION

This application claims priority from Japanese Patent Application No. 2006-56497, filed on Mar. 2, 2006.

### BACKGROUND

1. Technical Field

The present invention relates to technology for storing digital documents to be downloaded, and more particularly to technology for securely managing digital documents to be stored.

2. Related Art

There are instances where it is desirable to print documents while in an external environment, such as an outside location.

### SUMMARY

According to an aspect of the invention, there is provided a digital data storage apparatus including a digital data input unit that receives an upload of digital data, a digital data storage unit that stores the uploaded digital data, an authentication data generation unit that generates authentication data to associate with the stored digital data for accessing the digital data, an authentication data output unit that outputs the generated authentication data, an authentication data input unit that inputs authentication data together with identification data that identifies a download destination, an authentication unit that authenticates the input authentication data, and a digital data output unit that downloads, if authentication is successful, the digital data that has been associated to the authentication data to the download destination that is identified by the identification data.

### BRIEF DESCRIPTION OF THE DRAWINGS

Exemplary embodiments of the present invention will be described in detail based on the following figures, wherein:

FIG. 1 illustrates an example of a system configuration relating to the embodiment;

FIG. 2 is a flowchart showing a procedure at the storage operator side;

FIG. 3 shows an example of an A character string;

FIG. 4 is a flowchart showing a storage procedure at the print document storage server;

FIG. 5 is a flowchart showing a procedure at the print operator side; and

FIG. 6 is a flowchart showing a printing procedure at the image forming device and the print document storage server.

### DETAILED DESCRIPTION

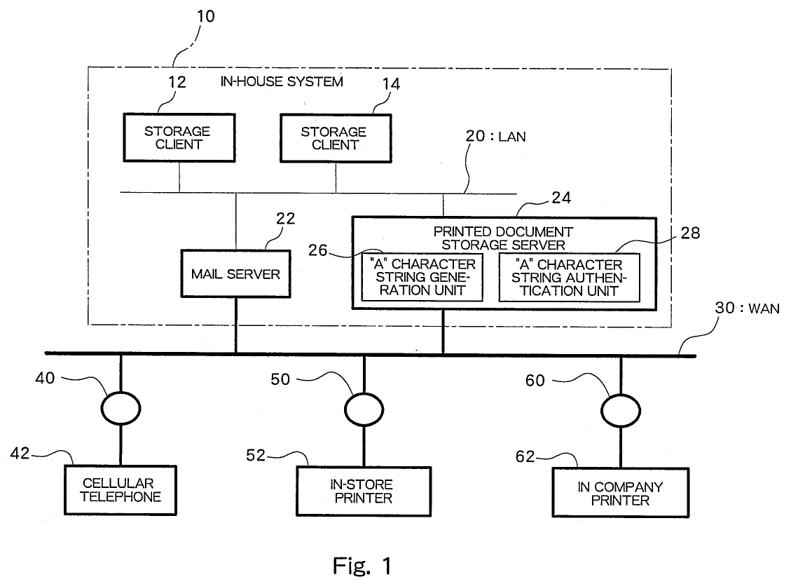

FIG. 1 illustrates a system configuration relating to the embodiment. Shown is an in-house system 10, which is a computer network system that is provided in a company. The in-house system 10 is provided with storage clients 12, 14 connected to a LAN (Local Area Network) 20. The storage operator clients 12, 14 are for use by a storage operator to perform settings so as to print documents outside the company and are composed using PCs (Personal Computers), which are used daily by the storage operator. The LAN 20 is further connected with a mail server 22 and a print document storage server 24. The mail server 22 is used for sending and receiving electronic mail within the LAN 20 and between the LAN 20 and the outside. Furthermore, the print document storage server 24 stores and manages the print documents as digital data. The print document storage server 24 receives uploads and internally stores print document from the storage operator clients 12, 14, such as via electronic mail, and provides downloads of print documents to an external printer on the basis of requests from the printer. Namely, the print document storage server 24 acts as a bridge for outputting digital documents within the in-house system 10 on the external printer.

To ensure the security of the print documents in this process, the print document storage server 24 is provided with an A character string generation unit 26 and an A character string authentication unit 28. The A character string generation unit 26 creates character string data (referred to as A character string) encrypted with an internally held key and corresponds to the stored print document. The created A character string is transmitted to the storage operator clients 12, 14 by the print document storage server 24. Furthermore, the A character string authentication unit 28 authenticates the A character string received from the printer and confirms whether or not the access is valid. In other words, the A character string authentication unit 28 confirms whether or not the request is from a user possessing the A character string, which was generated by the A character string generation unit 26, and confirms the validity of the access. The print document storage server 24 includes a function for performing encryption of the print document to be stored.

The in-house system 10 is connected to a WAN (Wide Area Network) 30, such as the Internet. To the WAN 30 is connected a cellular telephone network 40 to enable communications with a cellular telephone 42. The storage operator operating the storage operator clients 12, 14 can transmit an A character string, which is received after being stored into the printer, in electronic mail via the mail server 22 to a print operator having the cellular telephone 42. To the WAN 30 are further respectively connected an in-store printer 52 and an in-company printer 62 as an image forming system via firewalls 50, 60 for restricting access from the outside. The in-store printer 52 is located in a convenience store for use by ordinary users. Furthermore, the in-company printer 62 is located at another company or ASP (Application Service Provider). The print operator who received the A character string transmits electronic mail that includes the A character string to the in-store printer 52 or the in-company printer 62 so that the corresponding print document can be printed. After the received A character string is transmitted to the print document storage server 24 and authenticated, the in-store printer 52 or the in-company printer 62 downloads and prints the print document corresponding to the A character string.

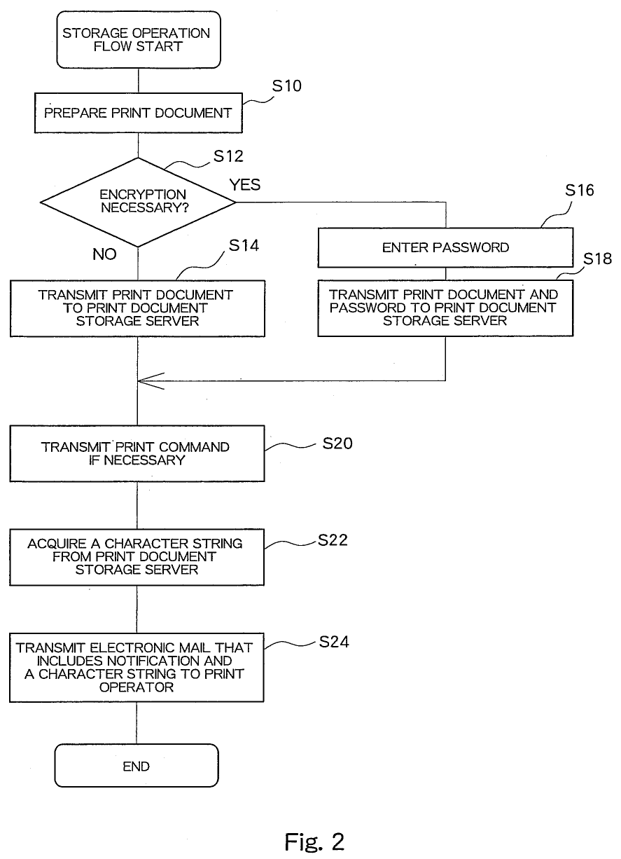

Next, the process for printing the print document using the system shown in FIG. 1 will be described with reference to the figures from FIG. 2 to FIG. 6.

FIG. 2 is a flowchart showing a procedure that is performed in the storage operator clients 12, 14. The storage operator clients 12, 14 first prepare (S10) the print document to be printed. The print document is created, for example, by using word processing software or spreadsheet software or by scanning a paper document. Furthermore, the print document is not limited to any format but is preferably in a format, such as PDF, that is usable on many printers.

Next, the storage operator clients 12, 14 determines (S12) whether or not to encrypt a print document at the time of storage. Encryption is often performed on highly confidential print documents. On the other hand, there are instances where general print documents having low confidentiality (for example, advertisements, catalogs, general documents) are not encrypted and processed in a simple manner. When encryption is not to be performed, the storage operator transmits the print document directly to the print document storage server 24. Furthermore, when encryption is to be performed, a password for the encryption is input (S16) and the print document is transmitted (S18) together with the password to the print document storage server 24. Then, when a command is issued to set the print settings for the print document, the command is also transmitted (S20) to the print document storage server 24. The print settings refer to commands to be executed for the printer, such as double-sided printing, staple processing, N-up printing, and so forth.

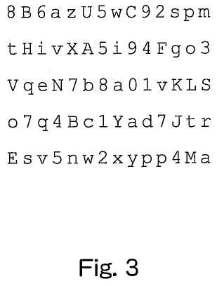

After storage, an A character string is transmitted (S22) to the storage operator clients 12, 14 from the print document storage server 24. The A character string is a digital document that is created for every print document that is stored. An example of the A character string will be described using FIG. 3. The A character string is created by using a key held within the print document storage server 24 to encrypt identification information that uniquely identifies a print document, information on the storage location of the print document, information indicating whether or not the print document is encrypted, and so forth. The A character string shown in the figure is formed from 70 characters of 14 characters by 5 lines, uses numbers (0-9), upper case alphabets (A-Z), and lower case alphabets (a-z), and allows for characters to be duplicated. The A character string can be included in the body of electronic mail and thus can be transmitted using electronic mail.

This A character string becomes necessary when fetching a stored print document from the print document storage server 24. If the print operator is different from the storage operator or if the print operator is the same as the storage operator but the terminal used for printing is different, electronic mail that includes the A-character string is transmitted (S24) from the storage operator clients 12, 14 to the (device used by the) print operator. Besides printing instructions to the print operator, the electronic mail can naturally include an ordinary message.

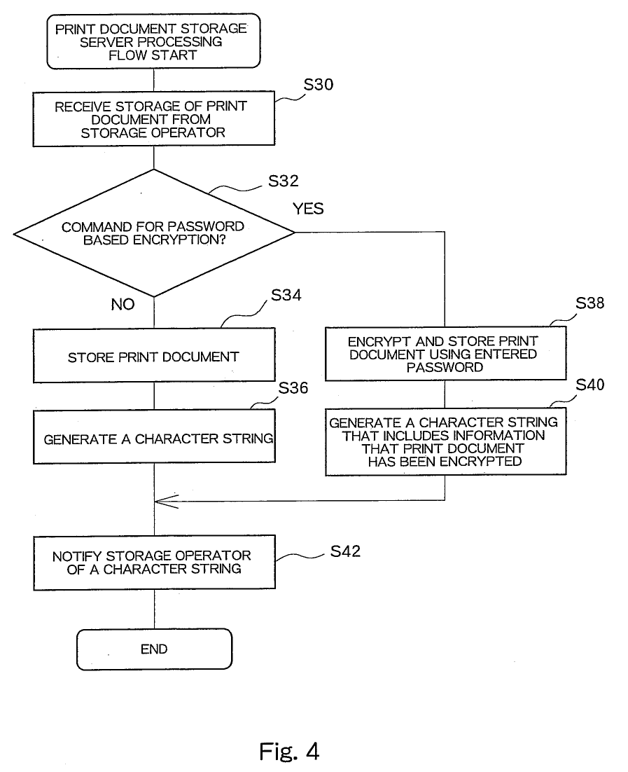

FIG. 4 is a flowchart showing a procedure that is performed at the print document storage server. The print storage server 24 receives (S30) a print document that is input from the storage operator clients 12, 14 or receives an input, if present, such as a password or a command relating to print settings. Next, the print document storage server 24 confirms (S32) whether a password was input and encryption was commanded. If there is no command for encryption, the print document is stored (S34) in an appropriate location without being encrypted and an A character string is created (S36) for the print document. On the other hand, if there is a command for encryption, the print document is encrypted by a password that has been input, stored (S38) to an appropriate location, and an A character string is created (S40) to include information to indicate that encryption was performed. The A character string created in this manner is transmitted (S42) via electronic mail to the storage operator clients 12, 14 that input the print document. When a command is received to specify the transmission destination of the A character string from the storage operator clients 12, 14, it is also possible to transmit to the transmission destination.

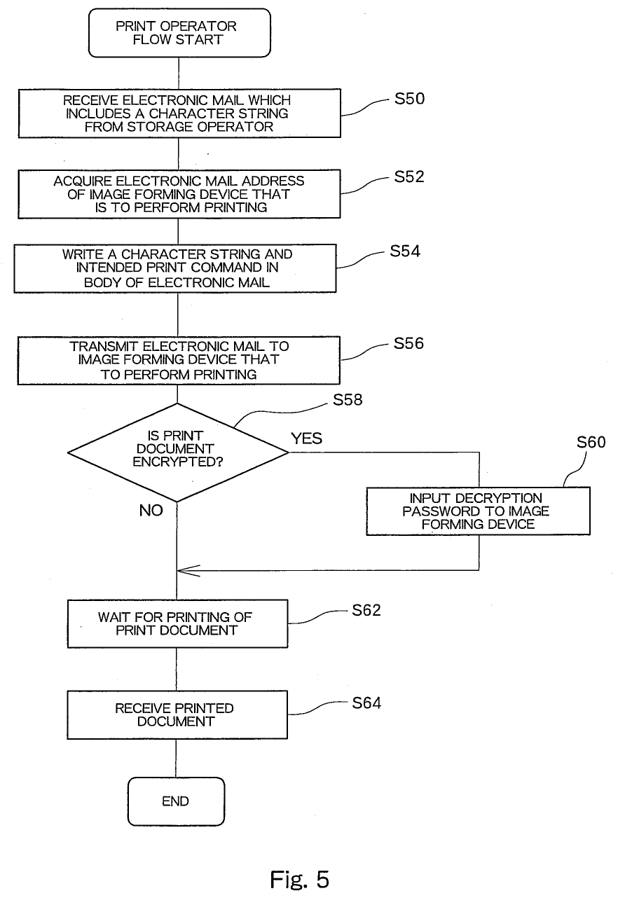

FIG. 5 is a flowchart showing a procedure that the print operator performs using the cellular telephone 42. Electronic mail that includes the A character string is transmitted (S50) to the cellular telephone 42 from the storage operator clients 12, 14. If it is desired to print the print document corresponding to the A character string, the print operator inputs (S52) to the cellular telephone 42 an electronic mail address of an image forming device (in this case the in-store printer 52) that performs printing. If, for example, the electronic mail address is written near the in-store printer 52, the input is performed manually or by inputting a photograph by the user. Next, the print operator creates (S54) electronic mail, which includes the A character string and a command for the print setting to be realized, on the cellular telephone 42. If the print setting is to be used at the default setting, it is not necessary to issue a command for the print setting. Furthermore, since the A character string includes information on the print document, it is not particularly necessary for the print operator to specify other information identifying the print document. The electronic mail created in this manner is transmitted (S56) to the in-store printer 52.

If the print document is encrypted at the in-store printer 52 (or print document storage server 24) and it is judged that a password input is required for decryption, a notification regarding this is sent to the cellular telephone 42 and the print operator transmits (S58, S60) the decryption password to the in-store printer 52. Thereafter, the print operator waits for the print document to print (S62) and then receives the printed document (S64). If the print operator is not in front of the in-store printer 52 at the time of printing, the procedure can be designed to pause after pre-processing for printing completes. The printing can then be resumed as soon as the print operator directly enters commands on the operating panel of the in-store printer 52.

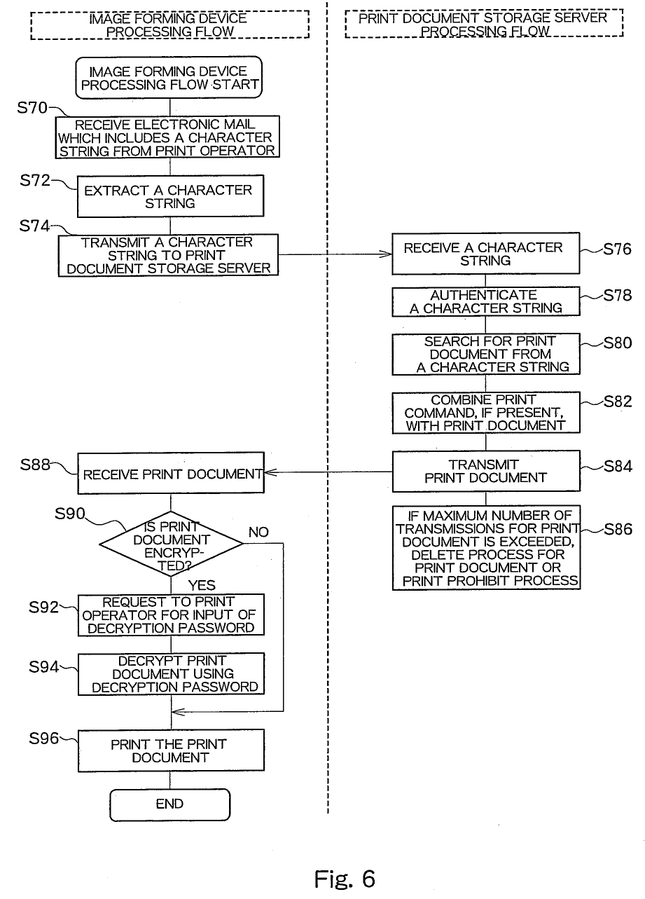

FIG. 6 is a flowchart showing a procedure at the in-store printer 52 as an image forming device and the print document storage server 24. The in-store printer 52 receives (S70) print commands for a print document by receiving electronic mail, which includes the A character string, from the cellular telephone 42 operated by the print operator. Then, the A character string and command information for the print setting within the electronic mail are extracted (S72) and transmitted (S74) to the print document storage server 24.

The print document storage server 24 receives (S76) the transmitted A character string and performs authentication (S78) by a comparison with internal data. Then, if authentication is successful, on the basis of the information included in the A character string, a search (S80) is performed for the corresponding print document. Furthermore, if there is a command for the print setting, an adjustment is performed with the command for the print setting that has been set for the print document at the time of storage and the print command to be adopted is generated. The generated print command is implemented, for example, as a job ticket and combined (S82) with the print document and transmitted (S84) to the in-store printer 52.

Accounting is performed when the print document is transmitted. The charged destination is typically performed with respect to a preset payee. Examples of a payee are the print operator or the print document storage operator or the company to which they belong. The charged destination can be dynamically determined on the basis of the information that is input from the in-store printer 52. For example, if the reverse side of the paper on which is printed the print document has an advertisement, the advertiser can be charged by conveying the advertiser information to the print document storage server 24. Furthermore, if the maximum number of transmissions has been exceeded, a process can be performed (S86) at the print document storage server 24 to delete the print document or prohibit printing.

When a print document that is transmitted from the print document storage server 24 is received, the in-store printer 52 confirms (S90) whether or not the print document has been encrypted. As a result, if the print document has been encrypted, an input request is made (S92) to the print operator for the decryption password and the print document is decrypted (S94) by the input decryption password. Then, the in-store printer 52 prints the print document on a paper sheet and the procedure terminates (S96).

An aspect was described hereinabove where a print document is downloaded to the image forming device and printed. However, when various types of digital data are downloaded, this technology is widely applicable. Specific examples include music delivery systems where music data is downloaded to portable music players and video delivery systems where video data is downloaded to cellular telephones.

Next, various variations of this embodiment will be described. The description overlaps with parts of the description hereinabove.

The digital data storage apparatus functions as a server for storing digital data. The digital data storage apparatus can be composed from a computer using hardware that has execution and memory functions, such as a workstation, PC (personal computer), and multifunction device (equipped with a printer, scanner, and facsimile), and software defining their operations. Each unit in the digital data storage apparatus may be implemented by centralized processing using a single hardware unit or may be implemented by distributed processing using multiple communication capable hardware units.

The digital data input unit receives digital data to be uploaded. An upload refers to a transfer via a network of digital data held by an upload origin as a client to the digital data storage apparatus as a server. Furthermore, a download refers conversely to a transfer of digital data from the digital data storage apparatus to a download destination as a client. Digital data refers to data that is electronically generated and is assumed herein particularly to have value and to be stored and managed, such as documents, music, videos, programs, and so forth. The upload origin of digital data is typically is a device that communicates via a wired or wireless network but may be a device that directly communicates via a dedicated cable or radio transmission. The digital data storage unit stores digital data, which is input from a digital data input unit, into a storage device, such as semiconductor memory or a hard disk. A data authentication generation unit generates authentication data for accessing digital data that is stored by the digital data storage unit. From the viewpoint of performing detailed access control, the authentication data may be created for every digital data item. Furthermore, from the viewpoint of simplifying access control, a common authentication data value may be created with respect to multiple digital data items. A authentication data output unit outputs the authentication data, which is generated from the authentication data generation unit, to another device.

An authentication data input unit inputs the authentication data together with identification data for identifying a download destination. The download destination is a device that operates as a client for downloading digital data. The download destination may be composed from a single hardware unit or from multiple hardware units connected so as to be capable of communication. Various examples of download destinations include image forming devices, PCs, cellular telephones, and portable music players. Identification data refers to data designating the output destination of digital data in the digital data output unit. Furthermore, the authentication data to be input may simply be identical to the authentication data that is output by the authentication data output unit or may be different from the output authentication data by including additional data added at the download destination. Moreover, the input origin of identification data and authentication data may be identical to or different from the output destination of the authentication data by the authentication data output unit or may be identical to or different from the download destination that is identified by the identification data.

The authentication unit performs an authentication process on the input authentication data and judges the success or failure of the authentication. The authentication process is performed by a comparison with the authentication data generated by the authentication data generation unit or by an algorithm corresponding to the authentication data generation at the authentication data generation unit. If authentication by the authentication unit is successful, the digital data output unit outputs digital data that has been associated with the generated authentication data to the download destination that is identified by the identification data.

In one aspect of the digital data storage apparatus, the authentication data generation unit generates authentication data formed from a character string that can be transmitted in the body of electronic mail. Data that can be transmitted in the body of electronic mail refers to data that can be transmitted without having to be attached. More specifically, this can refer to a character string in a text format.

In one aspect of the digital data storage apparatus, the authentication data output unit outputs the generated authentication data in electronic mail. The electronic mail can be sent to a prevalent communication unit, such a cellular telephone. If the authentication data output unit outputs the authentication data via electronic mail, it is possible to allow the authentication data input unit to input the authentication data via electronic mail. A communication protocol other than electronic mail, such as HTTP or FTP, can be employed for communications between an external device, including an upload origin or download destination, and the digital data storage apparatus.

In one aspect of the digital data storage apparatus, the authentication data generation unit includes an encryption unit for generating encrypted authentication data. In this case, when encrypted authentication data is input, the authentication unit performs decryption as necessary and thereafter executes an authentication process. Furthermore, in one aspect of the digital data storage apparatus, the encryption unit performs encryption with a key that can be decrypted only by the digital data storage apparatus. The key need not be a fixed value and may be a one-time password.

In one aspect of the digital data storage apparatus, the authentication data output unit outputs generated authentication data to a set other party. If the latter aspect is adopted, for example, the digital data may be downloaded by a third party connected through work or a third party as a subscriber to a mail magazine.

In one aspect of the digital data storage apparatus, the digital data unit receives a password that is input from the upload origin of the digital data, the authentication data input unit receives a password that is input from the input origin of the authentication data, and the digital data storage apparatus performs authentication of the input origin on the basis of both input passwords. Both passwords may be identical or may be different and have an associative relationship. To ensure the security of the digital data to be stored in this aspect, it is also possible to encrypt the digital data using the password that is input from the upload origin of the digital data and to decrypt the digital data using the password that is input from the input origin of the authentication data. Furthermore, as a modified example, it is also possible to perform encryption at the upload origin instead of performing password based encryption at the digital data storage apparatus and to perform decryption at the download destination instead of performing password based decryption at the digital data storage apparatus.

In one aspect of the digital data storage apparatus, a charge unit is further included for performing charge processing with respect to usage of digital data. Charge processing may be directly performed for the user of the download destination or the user of the upload origin or may be performed for a third party that has been preset or indicated during execution.

In one aspect of the digital data storage apparatus, the digital data to be downloaded is a print document. The print document is digital data to be printed and refers to data, such as characters, graphics, images, and so forth, written in an appropriate format, such as a vector format or a raster format.

In one aspect of the digital data storage apparatus, the download destination is an image forming system. The image forming system here refers to an apparatus that includes a printer (image forming device) for printing and a related control unit. The image forming system may include only the printer function or may be multifunction device that also includes functions for a scanner and a facsimile.

In one aspect of the digital data storage apparatus, the digital data input unit receives command data for print setting-that is input from the upload origin of the digital data, the authentication data input unit receives command data for print setting that is input from the input origin of the authentication data, the digital data storage apparatus includes a command data generation unit for generating command data for the print setting to be adopted on the basis of the received command data for both print settings, and the digital data output unit also outputs the command data for the print setting that is generated to the image forming system. The command data for the print setting refers to print control commands, such as for double-sided printing, N-up printing, staple processing, and so forth. Since it is conceivable for the contents of both command data to conflict, an algorithm may be provided for deciding on the command data, such as by applying an order of precedence to the command data.

To further improve the communication security in the above-mentioned present invention, it is also possible to introduce encryption technology or user authentication technology utilizing public key encryption in the digital data upload process or download process or in the input process or the output process for the authentication data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A digital data storage apparatus comprising:
a digital data input unit that receives an upload of digital data;
a digital data storage unit that stores the uploaded digital data;
an authentication data generation unit that generates authentication data to associate with the stored digital data for accessing the digital data;
an authentication data output unit that outputs the generated authentication data;
an authentication data input unit that inputs authentication data together with identification data that identifies a download destination;
an authentication unit that authenticates the input authentication data; and
a digital data output unit that downloads, if authentication is successful, the digital data that has been associated to the authentication data to the download destination that is identified by the identification data.

2. A digital data storage apparatus according to claim 1, wherein:
the authentication data generation unit generates, for each stored digital data, the authentication data that can uniquely identify the digital data.

3. A digital data storage apparatus according to claim 1, wherein:
the authentication data generation unit generates the authentication data formed from a character string that can be transmitted in an electronic mail body.

4. A digital data storage apparatus according to claim 3, wherein:
the authentication data output unit outputs the generated authentication data in electronic mail.

5. A digital data storage apparatus according to claim 1, wherein:
the authentication data generation unit comprises an encryption unit and generates the authentication data that is encrypted by the encryption unit.

6. A digital data storage apparatus according to claim 5, wherein:
the encryption unit performs encryption using a key that can be decrypted only by the digital data storage apparatus.

7. A digital data storage apparatus according to claim 1, wherein:
the authentication data output unit outputs the generated authentication data to an upload origin of the corresponding digital data.

8. A digital data storage apparatus according to claim 1, wherein:
the authentication data output unit outputs the generated authentication data to a set other party.

9. A digital data storage apparatus according to claim 1, wherein:
the digital data input unit receives a password that is input from an upload origin of the digital data;
the authentication data input unit also receives a password that is input from an input origin of the authentication data; and
the digital data storage apparatus performs authentication of the input origin on the basis of both input passwords.

10. A digital data storage apparatus according to claim 1, further comprising:
a charge unit that performs charging for usage of the digital data.

11. A digital data storage apparatus according to claim 1, wherein:
the digital data to be downloaded is a print document.

12. A digital data storage apparatus according to claim 11, wherein:
the download destination is an image forming system.

13. A digital data storage apparatus according to claim 12, wherein:
the authentication data input unit inputs the authentication data from the image forming system at the download destination.

14. A digital data storage apparatus according to claim 12, wherein:
the digital data input unit receives command data for print setting that is input from the upload origin of the digital data;
the authentication data input unit receives command data for print setting that is input from the input origin of the authentication data;
the digital data storage apparatus comprises a command data generation unit that generates command data for print setting to be adopted on the basis of both received command data for print setting; and
the digital data output unit also outputs the generated command data for print setting to the image forming system.

15. A digital data storage method, the method comprising:
receiving an upload of digital data;
storing the uploaded digital data;
generating authentication data to associate with the stored digital data for accessing the digital data;
outputting the generated authentication data;
inputting authentication data together with identification data that identifies a download destination;
authenticating the input authentication data; and
downloading, if authentication is successful, the digital data that has been associated to the authentication data to the download destination that is identified by the identification data.

16. A computer readable medium storing a program causing a computer to execute a process for digital data storage, the processing comprising:
receiving an upload of digital data;
storing the uploaded digital data;
generating authentication data to associate with the stored digital data for accessing the digital data;
outputting the generated authentication data;
inputting authentication data together with identification data that identifies a download destination;
authenticating the input authentication data; and
downloading, if authentication is successful, the digital data that has been associated to the authentication data to the download destination that is identified by the identification data.

17. A digital data processing system comprising: a digital data input unit that receives an upload of digital data to be printed;
a digital data storage unit that stores the uploaded digital data;
an authentication data generation unit that generates authentication data to associate with the stored digital data for accessing the digital data;
an authentication data output unit that outputs the generated authentication data;
an authentication data input unit that inputs authentication data together with identification data that identifies a download destination;
an authentication unit that authenticates the input authentication data;
a digital data output unit that downloads, if authentication is successful, the digital data that has been associated to the authentication data to the download destination that is identified by the identification data; and
an image forming system that is the download destination and prints the digital data that is downloaded.

18. A digital data processing system according to claim 17, wherein:
the authentication data input unit inputs the authentication data from the image forming system at the download destination.

19. A digital data processing system according to claim 17, wherein:
the digital data input unit receives command data for print setting that is input from the upload origin of the digital data;
the authentication data input unit receives command data for print setting that is input from the input origin of the authentication data;
the digital data storage apparatus comprises a command data generation unit that generates command data for print setting to be adopted on the basis of both received command data for print setting; and
the digital data output unit also outputs the generated command data for print setting to the image forming system.
